(19) United States
(12) Patent Application Publication
(10) Pub. No.: US 2023/0173909 A1
(43) Pub. Date: Jun. 8, 2023

(54) Low-Drag Loss Hybrid Transmission in a Composite Design

(71) Applicant: ZF Friedrichshafen AG, Friedrichshafen (DE)

(72) Inventors: Stefan Beck, Eriskirch (DE); Fabian Kutter, Kressbronn (DE); Johannes Kaltenbach, Friedrichshafen (DE); Matthias Horn, Tettnang (DE); Thomas Martin, Weissensberg (DE); Michael Wechs, Weißensberg (DE); Max Bachmann, Friedrichshafen (DE); Mladjan Radic, Langenargen (DE)

(21) Appl. No.: 18/072,992

(22) Filed: Dec. 1, 2022

(30) Foreign Application Priority Data
Dec. 2, 2021 (DE) 10 2021 213 669.9

(51) Int. Cl. B60K 6/365; B60K 6/547; B60K 6/40; F16H 37/08; B60K 6/387; B60K 6/26; B60K 6/442; B60K 17/354

(52) U.S. Cl. CPC B60K 6/365; B60K 6/26; B60K 6/40; B60K 6/387; B60K 6/442; B60K 6/547; B60K 17/354; F16H 37/082; B60K 2006/268; B60Y 2200/92; F16H 2200/0078; F16H 2200/2005; F16H 2200/2043

(57) ABSTRACT

A hybrid transmission (18) for a motor vehicle drive train (12) of a motor vehicle (10) includes: a first transmission input shaft (24) for operatively connecting the hybrid transmission to an internal combustion engine (16); a second transmission input shaft (26) for operatively connecting the hybrid transmission to a first electric prime mover (14); an output shaft (28) for operatively connecting the hybrid transmission to a drive output (32); a planetary gear set (RS) connected to the first transmission input shaft and to the second transmission input shaft; spur gear pairs (ST1, ST2, ST3) arranged in multiple gear set planes for forming gear steps; and a plurality of gear change devices that include shift elements (A, B, C, D, E) for engaging gear steps. The output shaft is of a countershaft design, and the planetary gear set is interlockable when decoupled from the output shaft.

### CROSS-REFERENCE TO RELATED APPLICATION

The present application is related and claims priority to 102021213669.9 filed in the German Patent Office on Dec. 2, 2021, which is incorporated by reference in its entirety for all purposes.

### FIELD OF THE INVENTION

The present invention relates generally to a hybrid transmission, a motor vehicle drive train that includes a hybrid transmission of this type, a motor vehicle that includes a motor vehicle drive train of this type, and to a method for operating a motor vehicle drive train of this type.

### BACKGROUND

Vehicles are increasingly equipped with hybrid drives, i.e., with at least two different drive sources. Hybrid drives can contribute to the reduction of fuel consumption and pollutant emissions. Drive trains that include an internal combustion engine and one or multiple electric motor(s) have largely prevailed as a parallel hybrid or as a mixed hybrid. These types of hybrid drives have an essentially parallel arrangement of the internal combustion engine and the electric drive in the power flow. A superposition of the drive torques and a control with a purely internal combustion engine-generated drive or a purely electric motor-generated drive can be made possible. Since the drive torques of the electric drive and of the internal combustion engine can sum depending on the control, a comparatively smaller design of the internal combustion engine and/or the intermittent shut-down of the internal combustion engine are/is possible. As a result, a significant reduction of the carbon dioxide (CO₂) emissions can be achieved without significant losses of power and/or comfort. The possibilities and advantages of an electric drive can therefore be combined with the range, power, and cost advantages of internal combustion engines.

One disadvantage of the aforementioned hybrid drives is a generally more complex configuration, since both drive sources preferably transmit input power to an input shaft with only one transmission. As a result, the production of such transmissions is usually complex and costly. A reduction of the complexity of the configuration of a hybrid transmission is usually associated with a loss of variability.

This disadvantage can be at least partially overcome by dedicated hybrid transmissions (DHT), in which an electric machine is integrated into the transmission in order to implement the full range of functions. For example, in the transmission, in particular, the mechanical transmission part can be simplified, for example, by omitting the reverse gear, at least one electric machine being used instead.

Dedicated hybrid transmissions can arise from known transmission concepts, i.e., from dual-clutch transmissions, torque converter planetary transmissions, continuously variable transmissions (CVT), or automated manual transmissions. The electric machine preferably becomes part of the transmission.

Unexamined patent application DE 10 2013 215 114 A1 describes a hybrid drive of a motor vehicle, the hybrid drive including an internal combustion engine that has a drive shaft, an electric machine that has a rotor and is operable as a motor and as a generator, an automated manual transmission of a countershaft design including an input shaft and at least one output shaft, and a superposition gearbox of a planetary design including two input elements and one output element. With respect to this hybrid drive, it is provided that the superposition gearbox is arranged coaxially over a free end of the output shaft and that the first input element of the superposition gearbox is rotationally fixed to a hollow shaft arranged coaxially over the output shaft, the hollow shaft being rotationally fixable to an idler gear of the directly axially adjacent spur gear stage of the change-speed transmission for coupling the internal combustion engine using a coupling shift element and being rotationally fixable to the second input element or to the output element of the superposition gearbox for bridging the superposition gearbox using a bypass shift element. It is also provided that the second input element of the superposition gearbox is permanently drivingly connected to the rotor of the electric machine and that the output element of the superposition gearbox is rotationally fixed to the output shaft.

### SUMMARY OF THE INVENTION

Example aspects of the present subject matter are directed to creating a compact hybrid transmission that has a simple mechanical configuration. In addition, a drive train configuration is preferably to be realized, in which the hybrid transmission is positioned coaxially to the output shafts and the internal combustion engine and/or the electric prime mover can be arranged axially parallel thereto. In particular, example aspects of the present subject matter are directed to creating a transmission, with which charging in neutral, electrodynamic starting off (EDA), and electrodynamic gear shifts (EDS) are possible.

In an example embodiment, a hybrid transmission for a motor vehicle drive train of a motor vehicle is provided. The hybrid transmission includes:
a first transmission input shaft for operatively connecting the hybrid transmission to an internal combustion engine of the motor vehicle;
a second transmission input shaft for operatively connecting the hybrid transmission to a first electric prime mover of the motor vehicle;
an output shaft for operatively connecting the hybrid transmission to a drive output;
a planetary gear set, which is connected to the first transmission input shaft and to the second transmission input shaft;
spur gear pairs arranged in multiple gear set planes for forming gear steps; and
a plurality of gear change devices that include shift elements for engaging gear steps, wherein
the output shaft is of a countershaft design; and
the planetary gear set is interlockable when decoupled from the output shaft.

In an example embodiment, a motor vehicle drive train for a motor vehicle is provided. The motor vehicle drive train includes:
a hybrid transmission as described above;
an internal combustion engine, which is connectable to the first transmission input shaft; and
a first electric prime mover, which is drivingly connected to the second transmission input shaft.

In an example embodiment, a method for operating a motor vehicle drive train as described above is also provided.

Finally, in an example embodiment, a motor vehicle is provided that includes:
a motor vehicle drive train as described above; and
an energy accumulator for storing energy for supplying the first electric prime mover and/or a second electric prime mover.

It is understood that the features, which are mentioned above and which will be described in greater detail in the following, are usable not only in the particular combination indicated, but rather also in other combinations or alone, without departing from the scope of the present invention.

Due to a first transmission input shaft for operatively connecting the hybrid transmission to an internal combustion engine and a second transmission input shaft for operatively connecting the hybrid transmission to a first electric prime mover, a compact hybrid transmission can be created in a technically simple manner. An operative connection can be designed to be engageable or permanently engaged. Due to an output shaft for operatively connecting the hybrid transmission to a drive output, the output shaft being of a countershaft design, a compact hybrid transmission can be created. In particular, the output shaft can be considered as a countershaft. Consequently, a hybrid transmission can be created, in which the countershaft also functions as an output shaft and is axially parallel to the first transmission input shaft and to the second transmission input shaft. Due to a planetary gear set that is connected to the first transmission input shaft and to the second transmission input shaft, a compact hybrid transmission that has a high range of functions can be created. In particular, a hybrid transmission can be created, with which charging in neutral, an electrodynamic starting off, and electrodynamic gear shifts are possible. Due to the fact that the planetary gear set is interlockable when decoupled from the output shaft, a highly efficient, pure electric motor gear step can be established. In particular, a hybrid transmission that has a simple configuration and only three actuators can be created in a compact design. The hybrid transmission has a low component load, low transmission losses, and good gearing efficiency during operation by the internal combustion engine and by the electric prime mover. Gear shifts in which the drive output is supported are possible with the transmission. In particular, the first electric prime mover is decoupleable in two of the gear steps, enabling a highly efficient operation purely under internal combustion engine power to be established. A transition from the charging-in-neutral condition or from the electrodynamic starting off can take place in all three mechanical gear steps for the internal combustion engine.

In one advantageous example embodiment, the first transmission input shaft is drivingly connectable to the output shaft via a first spur gear pair and a second spur gear pair of the spur gear pairs for forming the gear steps. As a result, at least two highly efficient, purely internal combustion engine gear steps can be established. Additionally or alternatively, the planetary gear set and/or the second transmission input shaft are/is connectable to the output shaft via a third spur gear pair of the spur gear pairs for forming the gear steps. As a result, an electrodynamic superposition condition can be established in a technically simple manner, in particular, by engaging only a single shift element. Moreover, an electric motor gear step can be established by engaging a single shift element and the charging-in-neutral condition can be established by engaging a single shift element.

In another advantageous example embodiment, the second transmission input shaft is designed as a hollow shaft and encompasses the first transmission input shaft at least partially or in sections. As a result, a compactness of the hybrid transmission can be improved. In particular, it is possible to advantageously mount the second transmission input shaft at the first transmission input shaft. In addition, due to a second transmission input shaft designed as a hollow shaft, the first electric prime mover can be connected at an outer side of the hybrid transmission. As a result, installation space can be created for an appropriately large first electric prime mover.

In another advantageous example embodiment, the hybrid transmission includes a transmission drive shaft, which is drivingly connected to the first transmission input shaft and is arranged axially parallel to the first transmission input shaft. Additionally or alternatively, the output shaft is drivingly operatively connected to a differential of the drive output, the differential including a differential shaft for transmitting drive power from the hybrid transmission to wheels of the motor vehicle, wherein the differential shaft is arranged axially parallel to the output shaft and is designed for mounting the first electric prime mover. Preferably, the transmission drive shaft is drivingly connected to the first transmission input shaft by a chain or a gear train. Due to the advantageous arrangement described above, the internal combustion engine can be connected axially in parallel to a transmission axis of the hybrid transmission. It is understood that a damper or a damper element can be additionally arranged at the transmission drive shaft. Due to the mounting of the first electric prime mover at a transmission shaft, the first electric prime mover can be mounted and arranged in the hybrid transmission in a highly efficient and space-saving manner. A compactness of the hybrid transmission can be further improved.

In another advantageous example embodiment, the planet carrier of the planetary gear set is drivingly connectable to the output shaft. Additionally, the sun gear of the planetary gear set is drivingly connected to the second transmission input shaft and the ring gear of the first planetary gear set is drivingly connected to the first transmission input shaft. Alternatively, the planet carrier of the planetary gear set is drivingly connectable to the output shaft and the ring gear of the first planetary gear set is drivingly connected to the second transmission input shaft and the sun gear of the planetary gear set is drivingly connected to the first transmission input shaft. Due to the two aforementioned alternative connections, the first electric prime mover can either be operated at a low compensating rotational speed during an electrodynamic starting off or electrodynamic gear shifts or apply only a small supporting torque during an electrodynamic starting off and during electrodynamic gear shifts. Moreover, due to the two alternative connections, a time duration of the operation as a generator during the electrodynamic starting off can be higher or lower.

In another advantageous example embodiment, the hybrid transmission includes an internal combustion engine clutch for detachably drivingly connecting the first transmission input shaft to the internal combustion engine, wherein the internal combustion engine clutch is preferably arranged at the transmission drive shaft. It is understood that the internal combustion engine clutch can be designed as a constant-mesh shift element, such as a dog clutch, or as a frictional shift element. The internal combustion engine can be decoupled from the hybrid transmission by an internal combustion engine clutch, and, in this way, a highly efficient, purely electrical traveling mode can be established by the hybrid transmission. In addition, a friction clutch enables a flywheel start of the internal combustion engine and can act as a starting component for the internal combustion engine. Due to an internal combustion engine clutch, the variability and the efficiency of the hybrid transmission can be increased. Moreover, an internal combustion engine clutch can be used in a hybrid transmission for reasons of operational safety.

In another advantageous example embodiment, the hybrid transmission includes precisely three spur gear pairs, precisely one planetary gear set, and precisely five shift elements for forming the gear steps. Due to the use of precisely three spur gear pairs and one planetary gear set, a compact hybrid transmission that has few meshing points can be created, the compact hybrid transmission enabling three hybrid gear steps having multiple variants, one pure electric motor gear step, one electrodynamic superposition condition, and one charging-in-neutral condition. Due to the use of precisely five shift elements, it can be achieved that the output shaft is designed free of shift elements. Moreover, an easily actuated, compact hybrid transmission can be created.

In another advantageous example embodiment, a first shift element is designed to drivingly connect the first transmission input shaft to the output shaft by a first spur gear pair. Additionally or alternatively, a second shift element is designed to drivingly connect the first transmission input shaft to the output shaft by a second spur gear pair. Moreover, additionally or alternatively, a third shift element is designed to drivingly connect the planetary gear set to the output shaft by a third spur gear pair. Moreover, additionally or alternatively, a fourth shift element is designed to drivingly connect the second transmission input shaft to the output shaft by a third spur gear pair. Additionally or alternatively, a fifth shift element is designed to interlock the planetary gear set, in particular, to drivingly connect the first transmission input shaft to the second transmission input shaft. Due to this advantageous arrangement of the shift elements, three hybrid gear steps having multiple variants and one pure electric motor gear step can be established with the hybrid transmission. A variable and compact hybrid transmission can be created, with which an electrodynamic starting off and electrodynamic gear shifts are possible.

In another advantageous example embodiment, at least two of the spur gear pairs for forming the gear steps are switchable with respect to their axial position. Additionally or alternatively, in the case of at least two spur gear pairs for forming the gear steps, an arrangement of the particular idler gear is switchable with the arrangement of the particular fixed gear. Finally, additionally or alternatively, the output shaft is designed free of shift elements. Due to spur gear pairs that are switchable with respect to their axial position and an interchange of the idler gear with the fixed gear of a particular spur gear pair, a variable hybrid transmission can be created, which can be, in particular, technically easily adapted to established installation space requirements. In particular, due to the switchability of the idler gears and the fixed gears, i.e., also the switching of a shift element from, for example, one input shaft onto the output shaft and/or vice versa, an advantageous accessibility of the shift elements can be enabled.

In another advantageous example embodiment, the shift elements are designed as form-locking shift elements. Additionally or alternatively, at least two of the shift elements, preferably four shift elements, are designed as a double shift element and are actuatable by a double-acting actuator. Form-locking shift elements enable a highly efficient and cost-effective hybrid transmission. The technical configuration and the operation of the hybrid transmission can be further simplified by a double shift element. In particular, a double shift element can be actuated by a single actuator.

In another advantageous example embodiment, the motor vehicle drive train preferably includes a further electric machine, which is drivingly connected to the first transmission input shaft. The first electric prime mover and/or, preferably, the further electric machine are/is actuatable as a starter generator for starting the internal combustion engine. Additionally or alternatively, the first electric prime mover and/or, preferably, the further electric machine are/is actuatable as a charging generator for charging an energy accumulator. The further electric machine is preferably designed as a high-voltage starter generator. As a result, an efficient motor vehicle drive train can be created. In particular, the fuel consumption can be reduced. It is understood that an additional starter for the internal combustion engine can be omitted, since the first electric prime mover and/or, preferably, the further electric machine can drag-start the internal combustion engine.

In another advantageous example embodiment, a drive output of the hybrid transmission is drivingly connectable to a first motor vehicle axle, wherein a second motor vehicle axle has an electric axle that includes a second electric prime mover. As a result, a hybrid drive train that has all-wheel drive can be created in a technically simple manner. Moreover, due to the motor vehicle drive train, gear shifting without tractive force interruption can be enabled in a technically simple manner, since the electric axle can maintain the tractive force during gear shifts in the hybrid transmission. In addition, a fail-safe drive train for a motor vehicle can be created, since a serial traveling mode is establishable in the case of a depleted energy accumulator for the second electric prime mover. In the serial traveling mode, the electric prime mover is preferably operated as a generator by the internal combustion engine and the energy generated in this way is provided to the second electric prime mover. As a result, a highly variable motor vehicle drive train can be created, in the case of which travel can take place electrically and, in particular, starting off can take place electrically even when the electrical energy accumulator is dead.

A fixation of an element of a planetary gear set is to be understood, in particular, as blocking a rotation of the element about the axis of rotation of the element. Preferably, the element is rotationally fixed to a static component, such as a frame and/or a transmission housing, by a shift element. It is also conceivable to decelerate the element to a standstill.

An interlock of a planetary gear set includes drivingly connecting two gearwheels and/or the planet carrier and one gearwheel of the planetary gear set such that these rotate together at the same speed about the same point, preferably the center of the planetary gear set. Upon interlocking two gearwheels and/or one planet carrier and one gearwheel of the planetary gear set, the planetary gear set preferably operates as a shaft. In particular, no multiplication takes place in the planetary gear set.

The expression “drivingly connected” is intended to mean, in this context, in particular, a permanent connection between two components, the permanent connection being provided for a permanent transmission of a rotational speed, a torque, and/or drive power. The connection can be implemented directly or via a fixed ratio. The connection can be implemented, for example, via a fixed shaft, a toothing, in particular a spur gear tooth system, and/or a wrap-around means, in particular a flexible traction drive mechanism, such as a chain or belt.

The expression “drivingly connectable,” “can be drivingly connected,” or “is designed for drivingly connecting” is intended to mean, in this context, in particular, a disengageable connection between two components, the disengageable connection being provided for a temporary transmission of a rotational speed, a torque, and/or a drive power in an engaged condition. In a disengaged condition, the disengageable connection preferably temporarily transmits essentially no rotational speed, no torque, and/or no drive power.

Stationary charging or charging-in-neutral is understood, in particular, to be the operation of the electric prime mover as a generator, preferably while the vehicle is at rest with the internal combustion engine running, in order to charge an energy accumulator and/or to supply onboard electronics.

An actuator in the present case is, in particular, a component that converts an electrical signal into a mechanical motion. Preferably, actuators that are used with double shift elements carry out movements in two opposite directions. In the first direction, the actuators actuate one shift element of the double shift element and, in the second direction, actuate the other shift element.

A gear step change, in particular a serial actuation, takes place, in particular, by disengaging one shift element and/or a clutch and simultaneously engaging the shift element and/or the clutch for the next higher or lower gear step. The second shift element and/or the second clutch therefore gradually take(s) on the torque from the first shift element and/or from the first clutch until, by the end of the gear step change, the entire torque has been taken on by the second shift element and/or the second clutch. If synchronization is carried out in advance, a gear ratio change can take place faster. Preferably, form-locking shift elements can be used in this case.

An internal combustion engine can be, in particular, any machine that can generate a turning motion by burning a fuel, such as gasoline fuel, diesel fuel, kerosene, ethanol, liquefied gas, liquefied petroleum gas, etc. An internal combustion engine can be, for example, a spark-ignition engine, a diesel engine, a Wankel rotary piston engine ®, or a two-stroke engine.

During a serial driving operation or creeping, an electric prime mover of a motor vehicle is operated as a generator by an internal combustion engine of the motor vehicle. The energy generated in this way is then provided to a further electric prime mover of the motor vehicle in order to provide drive power.

An electric vehicle axle, or electric axle, is preferably a non-main drive axle of a motor vehicle, in the case of which drive power can be transmitted to wheels of the motor vehicle by an electric prime mover. It is understood that the electric prime mover can also be connected by a transmission. A tractive force can be maintained in entirety or in part by an electric axle when a gear ratio change is implemented in the transmission for a main drive axle. Moreover, an all-wheel functionality can be at least partially established by an electric axle.

An electrodynamic starting component (EDA) causes the internal combustion engine speed and the electric prime mover speed to be superimposed via one or multiple planetary gear set(s) such that it is possible for a motor vehicle to pull off from rest while the internal combustion engine is running, preferably without a friction clutch. The electric prime mover supports a torque in this case. Preferably, the internal combustion engine is no longer disconnectable from the transmission by a launch clutch, or the like. Due to the use of an electrodynamic starting component, preferably the starter, the generator, and the launch clutch or hydrodynamic torque converter can be omitted. An electrodynamic starting component is, in particular, so compact that all components have space in the standard clutch housing without lengthening the transmission. The electrodynamic starting component can be fixedly connected to an internal combustion engine and, in particular, to a flywheel of an internal combustion engine, for example, by a softly tuned torsion damper. Therefore, the electric prime mover and the internal combustion engine can be operated either simultaneously or alternatively. If the motor vehicle stops, the electric prime mover and the internal combustion engine can be switched off. Due to a good controllability of the electric prime mover, a very high level of start-off quality is achieved, which can correspond to that of a drive that includes a converter clutch.

In the case of an electrodynamic gear shift (EDS), the internal combustion engine speed and the electric prime mover speed are superimposed via one or multiple planetary gear set(s) as in the case of an electrodynamic starting off. At the beginning of the gear shift, the torques of the electric prime mover and of the internal combustion engine are adapted such that the shift element to be disengaged becomes load-free. After this shift element has been disengaged, a rotational-speed adaptation takes place while the tractive force is maintained such that the shift element to be engaged is synchronized. After the shift element has been engaged, the load is arbitrarily distributed between the internal combustion engine and the electric prime mover depending on the hybrid operating strategy. The electrodynamic gear change operation has the advantage that the shift element of the target gear to be engaged is synchronized due to the interaction of the electric prime mover and the internal combustion engine, wherein the electric prime mover is preferably precisely controllable by way of a closed-loop system. Another advantage of the EDS gear change operation is that a high tractive force can be achieved, since the torques of the internal combustion engine and of the electric machine add up in the hybrid transmission.

### BRIEF DESCRIPTION OF THE DRAWINGS

Example aspects of the invention are described and explained in greater detail in the following with reference to a few selected exemplary embodiments in conjunction with the attached drawings, in which:

FIG. 1 shows a schematic top view of a motor vehicle that includes a motor vehicle drive train according to example aspects of the invention;

FIG. 2 shows a schematic view of a variant of a hybrid transmission according to example aspects of the invention;

FIG. 3 schematically shows the shift conditions of the example hybrid transmission according to FIG. 2;

FIGS. 4a, 4b show schematic views of further example variants of a hybrid transmission;

FIG. 5 shows a schematic view of a further example variant of a hybrid transmission;

FIG. 6 shows a schematic view of a further example variant of a hybrid transmission;

FIG. 7 shows a schematic view of a further example variant of a hybrid transmission;

FIG. 8 shows a schematic view of a further example variant of a hybrid transmission; and

FIG. 9 shows a schematic view of a further example variant of a hybrid transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

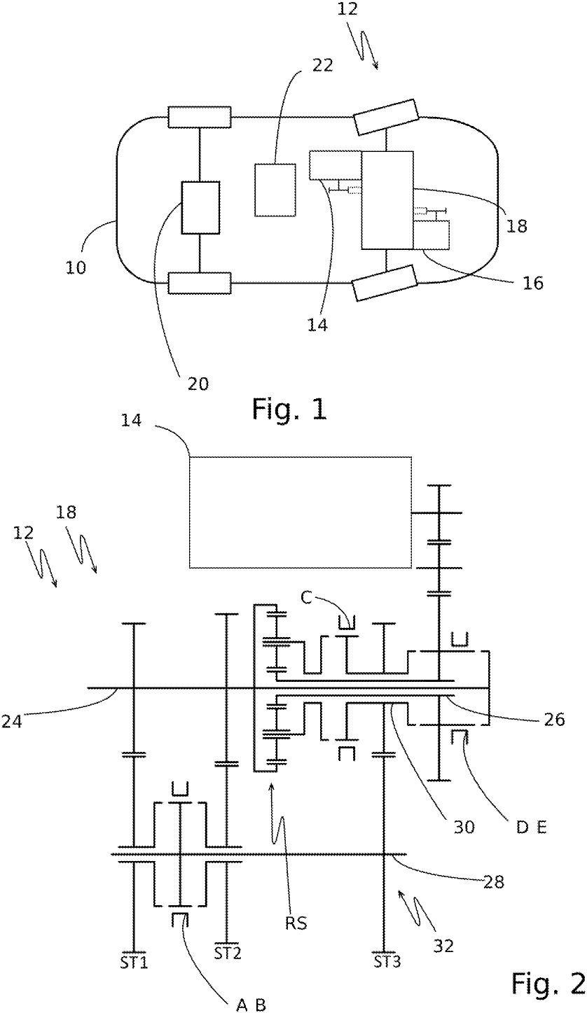

FIG. 1 schematically shows a motor vehicle 10 that includes a motor vehicle drive train 12. The motor vehicle drive train 12 includes a first electric prime mover 14 and an internal combustion engine 16, which are connected to a front axle of the motor vehicle 10 by a hybrid transmission 18. In the example shown, the motor vehicle drive train 12 also has an optional electric axle that includes a second electric prime mover 20, which is connected to a rear axle of the motor vehicle 10. It is understood that a reversed connection can also be implemented, such that the hybrid transmission 18 is connected to the rear axle of the motor vehicle 10 and the front axle of the motor vehicle 10 includes the electric axle. By the motor vehicle drive train 12, drive power of the first electric prime mover 14, of the internal combustion engine 16, and/or of the optional second electric prime mover 20 is supplied to the wheels of the motor vehicle 10. The motor vehicle 10 also includes an energy accumulator 22 in order to store energy, which is utilized for supplying the first electric prime mover 14 and/or the second electric prime mover 20.

FIG. 2 shows a simplified variant of a hybrid transmission 18 according to example aspects of the invention. The hybrid transmission 18 has a first transmission input shaft 24 and a second transmission input shaft 26, which are designed to transmit drive power of the prime movers 14, 16 into the hybrid transmission 18.

The hybrid transmission 18 also includes an output shaft 28 and a planetary gear set RS. A total of three spur gear pairs, designated as ST1 through ST3, are arranged in the hybrid transmission 18.

The hybrid transmission has five shift elements A, B, C, D, E.

The first electric prime mover 14 is drivingly connected to the second transmission input shaft 26 by a gear train including three fixed gears. The second transmission input shaft 26 is designed as a hollow shaft and encompasses the first transmission input shaft 24 at least partially or in sections.

Moreover, the second transmission input shaft 26 is drivingly connected to a sun gear of the planetary gear set RS. A planet carrier of the planetary gear set RS is drivingly connectable to an intermediate shaft 30, at which a fixed gear of the third spur gear pair ST3 is arranged. This fixed gear is in engagement with a fixed gear arranged at the output shaft 28.

The first spur gear pair ST1 includes a fixed gear that is arranged at the first transmission input shaft 24 and is in engagement with an idler gear arranged at the output shaft 28. The second spur gear pair ST2 likewise includes a fixed gear that is arranged at the first transmission input shaft 24 and is in engagement with an idler gear arranged at the output shaft 28. The internal combustion engine 16 (not shown) is designed to be drivingly connected to the first transmission input shaft 24. Moreover, the output shaft 28 is designed to be connected to a drive output 32 (not marked in greater detail) of the hybrid transmission 18.

The first shift element A is designed to drivingly connect the first spur gear pair ST1 to the output shaft 28 and is combined with the second shift element B to form a double shift element.

The second shift element B is designed to drivingly connect the second spur gear pair ST2 to the output shaft 28.

The third shift element C is configured as a single shift element and is designed to drivingly connect the third spur gear pair ST3 to the planet carrier of the planetary gear set RS.

The fourth shift element D is designed to drivingly connect the third spur gear pair ST3 to the second transmission input shaft 26.

The fourth shift element D is combined with a fifth shift element E to form a double shift element, wherein the fifth shift element E is designed to drivingly connect the first transmission input shaft 24 to the second transmission input shaft 26, i.e., to interlock the planetary gear set RS by drivingly connecting the ring gear and the sun gear of the planetary gear set RS to each other. It is understood that there are further possibilities for interlocking the planetary gear set RS, such as, for example, drivingly connecting the planet carrier to the ring gear or the planet carrier to the sun gear.

In the example shown, the first electric prime mover 14 is connected to the hybrid transmission 18 at a transmission side opposite the connection side of the internal combustion engine 16 (not shown).

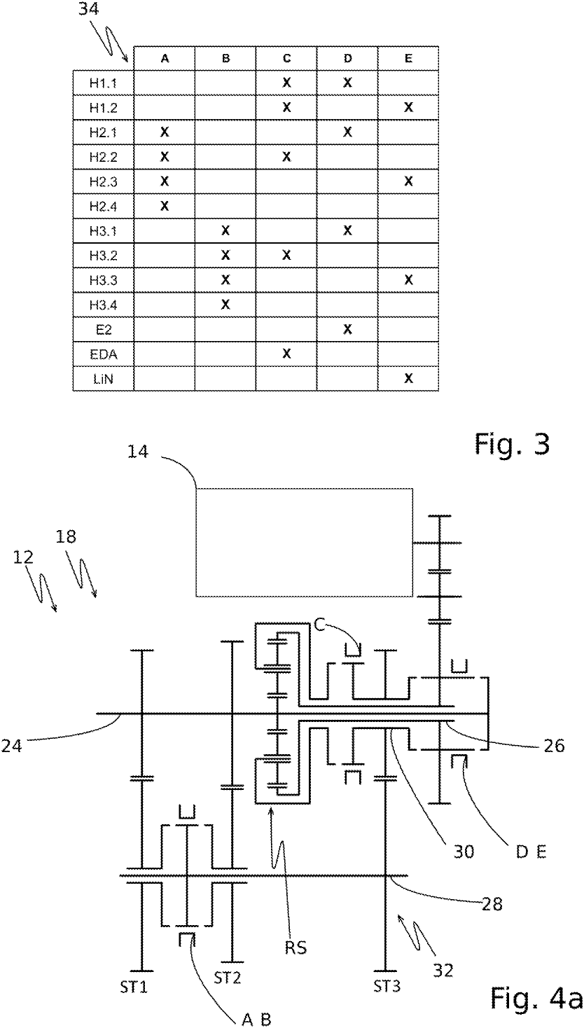

In FIG. 3, in a gear shift matrix 34, the hybrid gear steps H1 through H3, an electric motor gear step E2, an electrodynamic superposition condition EDA, and a charging-in-neutral condition LiN are shown in a first column. The shift conditions of the shift elements A through E are shown in the second through sixth columns, wherein an “X” means that the particular shift element is engaged, i.e., drivingly connects the associated transmission components to one another. If an entry is not present, it is to be assumed that the corresponding shift element is disengaged, i.e., does not transmit drive power.

A first variant of the first hybrid gear step H1.1 can be established by engaging the third shift element C and the fourth shift element D.

A second variant of the first hybrid gear step H1.2 can be established by engaging the third shift element C and the fifth shift element E.

An engagement of the first shift element A and of the fourth shift element D establishes a first variant of the second hybrid gear step H2.1.

A second variant of the second hybrid gear step H2.2 can be established by engaging the first shift element A and the third shift element C.

An engagement of the first shift element A and of the fifth shift element E establishes a third variant of the second hybrid gear step H2.3.

An engagement of the first shift element A establishes a fourth variant of the second hybrid gear step H2.4.

A first variant of the third hybrid gear step H3.1 can be established by engaging the second shift element B and the fourth shift element D.

An engagement of the second shift element B and of the third shift element C establishes a second variant of the third hybrid gear step H3.2.

A third variant of the third hybrid gear step H3.3 can be established by engaging the second shift element B and the fifth shift element E.

An engagement of the second shift element B establishes a fourth variant of the third hybrid gear step H3.4.

A pure electric motor gear step E2 can be established by engaging the fourth shift element D.

An engagement of the third shift element C establishes an electrodynamic superposition condition EDA.

The charging-in-neutral condition, LiN, can be established by engaging the fifth shift element E.

It is understood that the shift elements A through E are preferably designed as form-locking shift elements, for example, constant-mesh shift elements. It is also understood that a fixed ratio, for example, in the form of a further planetary gear set, or a spur gear stage, can be connected downstream from the gear set shown in FIG. 2. Moreover, a differential is preferably connected downstream from the gear set.

Three different hybrid driving gear steps for the internal combustion engine 16 are available for internal combustion engine-driven travel and hybrid travel.

If only the fourth shift element D is engaged, driving can take place under purely electric motor power, since the first electric prime mover 14 is directly connected to the drive output 32.

If only the third shift element C is engaged, an EDA condition arises at the planetary gear set RS. The internal combustion engine 16 is then connected to the ring gear of the planetary gear set RS, wherein the first electric prime mover 14 supports the torque of the internal combustion engine 16 at the sun gear of the planetary gear set RS. The planet carrier of the planetary gear set RS is connected to the drive output 32 via the third spur gear pair ST3. As a result, an EDA starting off in the forward direction is possible. Each of the three hybrid gear steps can be engaged for the internal combustion engine 16 from this EDA condition, because the third shift element C is engaged in the first variant of the first hybrid gear step H1.1, in the second variant of the first hybrid gear step H1.2, in the second variant of the second hybrid gear step H2.2, and in the second variant of the third hybrid gear step H3.2.

A gear shift from the first gear step into the second gear step can be carried out with drive output supported by the first electric prime mover 14, wherein the fourth shift element D remains engaged. Next, a switch takes place from the first variant of the first hybrid gear step H1.1 into the first variant of the second hybrid gear step H2.1. A gear shift from the second gear step into the third gear step can likewise be carried out with drive output supported by the first electric prime mover 14, wherein the fourth shift element D remains engaged. Here, a switch takes place from the first variant of the second hybrid gear step H2.1 into the first variant of the third hybrid gear step H3.1.

An electrodynamic powershift from the first variant of the first hybrid gear step H1.1 into the first variant of the second hybrid gear step H2.1 in the hybrid mode can take place, for example, as follows. In the basic condition, i.e., the first variant of the first hybrid gear step H1.1, the third shift element C and the fourth shift element D are engaged. A load reduction takes place at the third shift element C and a simultaneous load build-up takes place at the first electric prime mover 14. Next, the third shift element C is disengaged. The rotational speed of the internal combustion engine 16 is reduced, enabling the first shift element A to be synchronized. For this purpose, for example, a further electric prime mover can be operated as a generator or the internal combustion engine 16 can enter the coasting operation. Next, the second shift element B can be engaged. The fourth shift element D remains engaged during this gear shift.

If only the fifth shift element E is engaged, the first electric prime mover 14 can be connected to the internal combustion engine 16 independently of the drive output 32. The first electric prime mover 14 and the internal combustion engine 16 then rotate in a fixed ratio with respect to each other. In this way, on the one hand, a start of the internal combustion engine 16 by the first electric prime mover 14 is possible. Moreover, the first electric prime mover 14 can be operated as a generator by the internal combustion engine 16 and charge the electrical energy accumulator 22 or supply electrical consumers. A consumer can also be a second electric prime mover 20, as shown in FIG. 1, which drives, for example, the other vehicle axle. A transition from the charging-in-neutral condition, LiN, into all three hybrid gear steps is possible, because the fifth shift element E is engaged in the second variant of the first hybrid gear step H1.2, in the third variant of the second hybrid gear step H2.3, and in the third variant of the third hybrid gear step H3.3.

If, as shown, for example, in FIG. 1, an electric rear axle is present, an all-wheel drive system can be created with the aid of this combination. For example, a DHT, i.e., a dedicated hybrid transmission, that includes the internal combustion engine 16 and the first electric prime mover 14 can be designed as a pure front-wheel drive and an additional rear-axle drive can be implemented with the separate, second electric prime mover 20.

The electrodynamic superposition condition EDA is, in this case, a power-split E-CVT mode for the internal combustion engine 16, in which a battery-neutral operation is also possible. A CVT mode is to be understood, in particular, as a mode having a continuously variable ratio (continuously variable transmission).

The first electric prime mover 14 can be decoupled in the second gear step and the third gear step, in particular in the fourth variant of the second hybrid gear step H2.4 and in the fourth variant of the third hybrid gear step H3.4, if only the first shift element A or the second shift element B, respectively, is engaged. It is particularly advantageous here that zero-load losses are avoided when the first electric prime mover 14 is not required. An example of this type of mode is driving under purely internal combustion engine power.

Moreover, a support of tractive force can be implemented by the second electric prime mover 20. The second electric prime mover 20 can support the tractive force, for example, at the rear axle, when shifting processes are necessary in the hybrid transmission 18, in the case of which the drive output 32 of the hybrid transmission 18 becomes load-free. One example of a transition of this type is: When travel initially takes place purely electrically by the first electric prime mover 14 and/or the second electric prime mover 20 and, thereafter, a start of the internal combustion engine 16 in neutral is to take place by the first electric prime mover 14.

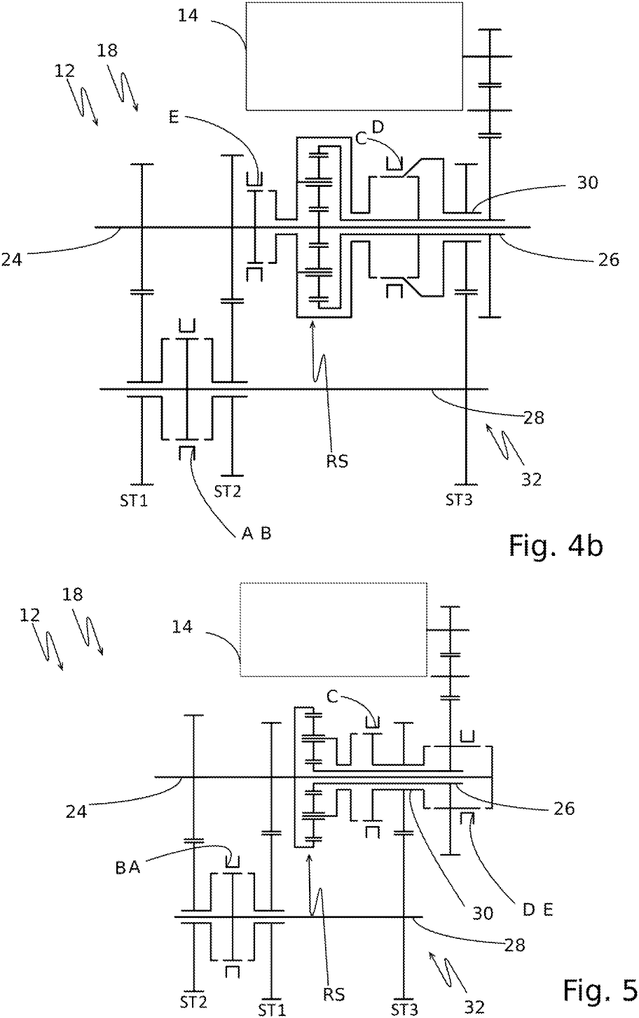

A further example variant of a hybrid transmission 18 according to the invention is shown in FIG. 4a. In contrast to the example embodiment shown in FIG. 2, the connections of the shafts at the planetary gear set RS have been switched. In particular, the second transmission input shaft 26 is drivingly connected to the ring gear of the planetary gear set RS, wherein the sun gear of the planetary gear set RS is drivingly connected to the first transmission input shaft 24. The connection at the planet carrier of the planetary gear set RS remains the same.

Due to the connection disclosed in FIG. 4a, the first electric prime mover 14 can be operated at a lower compensating rotational speed during an electrodynamic starting off (EDA) or electrodynamic gear shifts (EDS). However, the first electric prime mover 14 must apply a higher supporting torque during an electrodynamic starting off (EDA) or during electrodynamic gear shifts (EDS). Moreover, the first electric prime mover 14 can be operated as a generator for a shorter period of time during the electrodynamic starting off, since, as the speed of travel speed increases, the generator mode is exited earlier than would be the case if the first electric prime mover 14 were connected at the sun gear of the planetary gear set RS.

A further variant of a hybrid transmission 18 according to example aspects of the invention is shown in FIG. 4b. In contrast to the example embodiment shown in FIG. 4a, the arrangements of the fourth shift element D and of the fifth shift element E have been changed. The fourth shift element D is combined with the third shift element C to form a double shift element. The fifth shift element E is designed as a single shift element and is arranged between the planetary gear set RS and the second spur gear pair ST2.

A further variant of a hybrid transmission 18 according to example aspects of the invention is shown in FIG. 5. In contrast to the example embodiment shown in FIG. 2, the first spur gear pair ST1 and the second spur gear pair ST2 have been switched with respect to their geometric order. Consequently, as viewed from a connection side of the internal combustion engine 16 (not shown), the order of the arrangement in the hybrid transmission 18 is, initially, the second spur gear pair ST2, followed by the second shift element B, which is combined with the first shift element A to form a double shift element, and then the first spur gear pair ST1. The arrangement of the remaining transmission components corresponds to the arrangement as shown in FIG. 2.

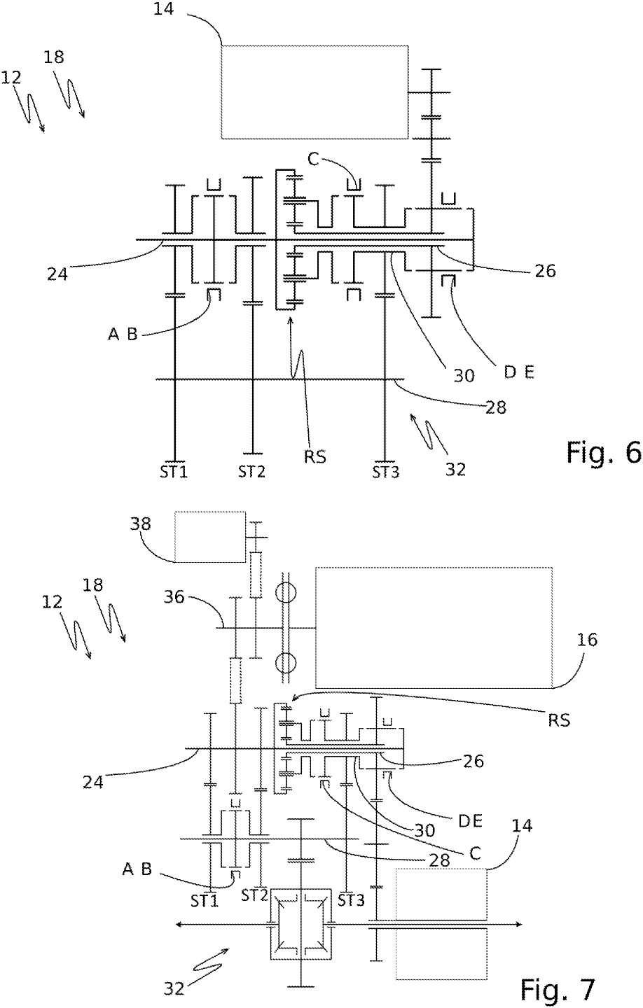

A further variant of a hybrid transmission 18 according to example aspects of the invention is shown in FIG. 6. In contrast to the example embodiment shown in FIG. 2, the fixed gears and the idler gears of the first spur gear pair ST1 and of the second spur gear pair ST2 are switched in each case. Consequently, the output shaft 28 has exclusively fixed gears, wherein the corresponding idler gears are arranged at the first transmission input shaft 24.

It is understood that a combination of the two example embodiments disclosed in FIGS. 5 and 6 is also possible. In other words, it is conceivable to switch the idler gear and the fixed gear in only one of the two spur gear pairs ST1, ST2 and to switch the spur gear pairs ST1 and ST2 with respect to their axial arrangement in the hybrid transmission 18.

A further variant of a hybrid transmission 18 according to example aspects of the invention is shown in FIG. 7. The hybrid transmission 18 according to FIG. 7 essentially corresponds to the hybrid transmission 18 shown in FIG. 2, wherein the drive output 32 is shown in greater detail in FIG. 7. The drive output 32 is formed by a fixed gear at the output shaft 28, the fixed gear being arranged between the second spur gear pair ST2 and the third spur gear pair ST3. This fixed gear is in engagement with a fixed gear arranged at a differential and, in this way, transmits drive power from the hybrid transmission 18 to the differential. The differential also includes a differential shaft, which extends through a rotor shaft of the first electric prime mover 14. In other words, the first electric prime mover 14 is mounted at the differential shaft.

Moreover, the hybrid transmission 18 includes a transmission drive shaft 36, which is arranged axially parallel to the first transmission input shaft 24 and is drivingly connected via a flexible traction drive mechanism, such as a belt or chain, to a fixed gear of the first transmission input shaft 24, the fixed gear being arranged between the first spur gear pair ST1 and the second spur gear pair ST2. The transmission drive shaft 36 is connected to the internal combustion engine 16 by a torsional vibration damper or another element for decoupling torsional vibrations that is conventionally known, in principle.

Moreover, a fixed gear is arranged at the transmission drive shaft 36 for connecting a further electric machine 38. The further electric machine 38 is operatively connected to the transmission drive shaft 36 by a flexible traction drive mechanism, such as a belt or chain. Particularly preferably, the further electric machine 38 can be designed as a high-voltage starter generator.

It is understood that the connection of the transmission drive shaft 36 to the first transmission input shaft 24 and to the further electric machine 38 can also be designed, alternatively, as a gear train.

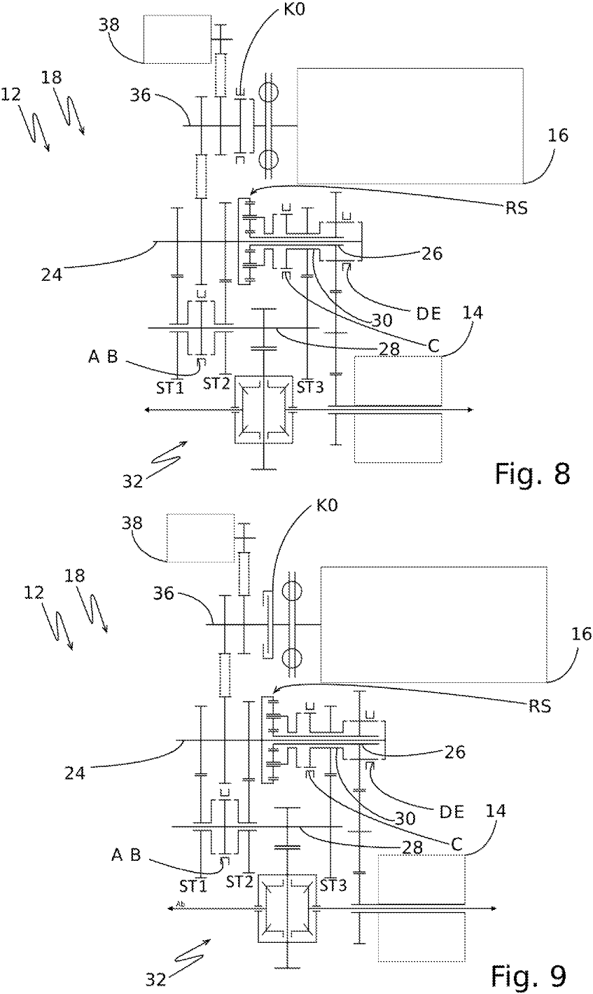

A further variant of a hybrid transmission 18 according to example aspects of the invention is shown in FIG. 8. In contrast to the example embodiment shown in FIG. 7, the transmission drive shaft 36 includes an internal combustion engine clutch K0. The internal combustion engine clutch K0 is designed to disconnectably drivingly connect the transmission drive shaft 36 to the internal combustion engine 16. The internal combustion engine clutch K0 is arranged between the element for decoupling torsional vibrations and the two connecting gearwheels of the transmission drive shaft 36, and so the further electric machine 38 is always drivingly connected to the first transmission input shaft 24.

In the example shown in FIG. 8, the internal combustion engine clutch K0 is designed as a form-locking shift element, for example, as a dog clutch.

A further variant of a hybrid transmission 18 according to example aspects of the invention is shown in FIG. 9. In contrast to the example embodiment shown in FIG. 8, the internal combustion engine clutch K0 is designed as a friction-locking shift element.

It is understood that the motor vehicle drive train 12 and the hybrid transmission 18 can also be operated without the internal combustion engine clutch K0. Nevertheless, an internal combustion engine clutch K0 can be useful for various reasons, such as, for example, reasons of operational safety. In particular, an internal combustion engine clutch K0 in the form of a friction-locking shift element, as shown in FIG. 9, enables a drag start of the internal combustion engine 16. An internal combustion engine clutch K0 is useful, in particular, in an embodiment that includes the further electric machine 38.

The invention has been comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized. Reference characters in the patent claims are not to be understood as limiting. A method for operating a motor vehicle drive train 12 can be implemented, for example, in the form of a computer program that is run on a control unit for the motor vehicle drive train 12. A computer program can be stored/distributed on a non-volatile data carrier, for example, on an optical memory or on a solid state drive (SSD). A computer program can be distributed together with hardware and/or as part of a piece of hardware, for example, by the Internet or by hard-wired or wireless communication systems.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

REFERENCE CHARACTERS

| | |
|---|---|
| 10 | motor vehicle |
| 12 | motor vehicle drive train |
| 14 | first electric prime mover |
| 16 | internal combustion engine |
| 18 | hybrid transmission |
| 20 | second electric prime mover |
| 22 | energy accumulator |
| 24 | first transmission input shaft |
| 26 | second transmission input shaft |
| 28 | output shaft |
| 30 | intermediate shaft |
| 32 | drive output |
| 34 | gear shift matrix |
| 36 | transmission drive shaft |
| 38 | further electric machine |
| A-E | shift elements |
| K0 | internal combustion engine clutch |

1-15. (canceled)

16. A hybrid transmission (18) for a motor vehicle drive train (12) of a motor vehicle (10), comprising:
a first transmission input shaft (24) configured for operatively connecting the hybrid transmission to an internal combustion engine (16) of the motor vehicle;
a second transmission input shaft (26) configured for operatively connecting the hybrid transmission to a first electric prime mover (14) of the motor vehicle;
an output shaft (28) configured for operatively connecting the hybrid transmission to a drive output (32);
a planetary gear set (RS) connected to the first transmission input shaft and to the second transmission input shaft;
a plurality of spur gear pairs (ST1, ST2, ST3) arranged in multiple gear set planes for forming gear steps; and
a plurality of sift elements (A, B, C, D, E) for engaging the gear steps,
wherein the output shaft is of a countershaft design; and
wherein the planetary gear set is interlockable when decoupled from the output shaft.

17. The hybrid transmission (18) of claim 16, wherein:
the plurality of spur gear pairs (ST1, ST2, ST3) comprises a first spur gear pair (ST1), a second spur gear pair (ST2), and a third spur gear pair (ST3);
the first transmission input shaft (24) is drivingly connectable to the output shaft (28) via the first spur gear pair (ST1) and a second spur gear pair (ST2); and
the planetary gear set (RS) and/or the second transmission input shaft (26) is connectable to the output shaft (28) via the third spur gear pair (ST3).

18. The hybrid transmission (18) of claim 16, wherein the plurality of spur gear pairs (ST1, ST2, ST3) comprises a first spur gear pair (ST1), a second spur gear pair (ST2), and a third spur gear pair (ST3), and wherein:
the first transmission input shaft (24) is drivingly connectable to the output shaft (28) via the first spur gear pair (ST1) and a second spur gear pair (ST2); or
the planetary gear set (RS) and/or the second transmission input shaft (26) is connectable to the output shaft (28) via the third spur gear pair (ST3).

19. The hybrid transmission (18) of claim 16, wherein the second transmission input shaft (26) is a hollow shaft and at least partially encompasses the first transmission input shaft (24).

20. The hybrid transmission (18) of claim 16, further comprising a transmission drive shaft (36), wherein:
the transmission drive shaft (36) is drivingly connected to the first transmission input shaft (24) and is arranged axially parallel to the first transmission input shaft; and/or
the output shaft (28) is drivingly operatively connected to a differential of the drive output (32), the differential comprising a differential shaft configured for transmitting drive power from the hybrid transmission to wheels of the motor vehicle (10), the differential shaft arranged axially parallel to the output shaft (28) and configured for supporting the first electric prime mover (14).

21. The hybrid transmission (18) of claim 16, wherein
the planet carrier of the planetary gear set (RS) is drivingly connectable to the output shaft (28), the sun gear of the planetary gear set (RS) is drivingly connected to the second transmission input shaft (26), and the ring gear of the planetary gear set (RS) is drivingly connected to the first transmission input shaft (24); or
the planet carrier of the planetary gear set (RS) is drivingly connectable to the output shaft (28), the ring gear of the planetary gear set (RS) is drivingly connected to the second transmission input shaft (26), and the sun gear of the planetary gear set (RS) is drivingly connected to the first transmission input shaft (24).

22. The hybrid transmission (18) of claim 16, further comprising an internal combustion engine clutch (K0) configured for detachably drivingly connecting the first transmission input shaft (24) to the internal combustion engine (16).

23. The hybrid transmission (18) of claim 22, wherein the internal combustion engine clutch is arranged at the transmission drive shaft (36).

24. The hybrid transmission (18) of claim 16, wherein the plurality of spur gear pairs (ST1, ST2, ST3) is precisely three spur gear pairs (ST1, ST2, ST3), the plurality of shift elements is precisely five shift elements (A, B, C, D, E), and the hybrid transmission (18) has precisely one planetary gear set (RS).

25. The hybrid transmission (18) of claim 16, wherein one or more of:
a first shift element (A) of the plurality of shift elements is configured to drivingly connect the first transmission input shaft (24) to the output shaft (28) by a first spur gear pair (ST1) of the plurality of spur gear pairs (ST1, ST2, ST3);
a second shift element (B) of the plurality of shift elements is configured to drivingly connect the first transmission input shaft (24) to the output shaft (28) by a second spur gear pair (ST2) of the plurality of spur gear pairs (ST1, ST2, ST3);
a third shift element (C) of the plurality of shift elements is configured to drivingly connect the planetary gear set (RS) to the output shaft (28) by a third spur gear pair (ST3) of the plurality of spur gear pairs (ST1, ST2, ST3);
a fourth shift element (D) of the plurality of shift elements is configured to drivingly connect the second transmission input shaft (26) to the output shaft (28) by the third spur gear pair (ST3); and
a fifth shift element (E) of the plurality of shift elements is configured to interlock the planetary gear set (RS).

26. The hybrid transmission (18) of claim 16, wherein one or more of:
at least two spur gear pairs (ST1, ST2, ST3) of the plurality of spur gear pairs (ST1, ST2, ST3) are switchable with respect to axial position;
for at least two of the plurality of spur gear pairs (ST1, ST2, ST3), an arrangement of a respective idler gear of the at least two of the plurality of spur gear pairs (ST1, ST2, ST3) is switchable with a respective fixed gear of the at least two of the plurality of spur gear pairs (ST1, ST2, ST3); and
the output shaft (28) is free of shift elements.

27. The hybrid transmission (18) of claim 16, wherein one or both of:
the plurality of shift elements (A, B, C, D, E) are form-locking shift elements; and
at least two of the plurality of shift elements (A, B, C, D, E) are configured as a double shift element, each of which is actuatable by a respective double-acting actuator.

28. The hybrid transmission (18) of claim 27, wherein four of the plurality of shift elements (A, B, C, D, E) are configured as double shift elements.

29. A motor vehicle drive train (12) for a motor vehicle (10), comprising:
the hybrid transmission (18) of claim 16;
an internal combustion engine (16) connectable to the first transmission input shaft (24); and
a first electric prime mover (14) drivingly connectable to the second transmission input shaft (26).

30. The motor vehicle drive train (12) of claim 29, further comprising an electric machine (38) drivingly connected to the first transmission input shaft (24), wherein the first electric prime mover (14) and/or the electric machine is one or both of:
actuatable as a starter generator for starting the internal combustion engine (16); and
actuatable as a charging generator for charging an energy accumulator (22).

31. The motor vehicle drive train (12) of claim 29, wherein:
the drive output (32) of the hybrid transmission (18) is drivingly connectable to a first motor vehicle axle, and a second motor vehicle axle comprises an electric axle with a second electric prime mover (20); and
one or both of the first electric prime mover (14) and the electric machine (38) is actuatable as a generator for supplying the second electric prime mover (20) in order to establish a serial driving mode.

32. A motor vehicle (10), comprising:
the motor vehicle drive train (12) of claim 29; and
an energy accumulator (22) for storing energy for supplying one or both of the first electric prime mover (14) and a second electric prime mover (20).
